(19) United States
(12) Patent Application Publication
(10) Pub. No.: US 2013/0290209 A1
(43) Pub. Date: Oct. 31, 2013

(54) CrowdSourced Wiki Resume

(71) Applicant: Christopher R. Wirz, Corning, NY (US)

(72) Inventor: Christopher R. Wirz, Corning, NY (US)

(73) Assignee: YouFolio LLC, Vienna, VA (US)

(21) Appl. No.: 13/851,352

(22) Filed: Mar. 27, 2013

Related U.S. Application Data
(60) Provisional application No. 61/619,928, filed on Apr. 3, 2012.

(51) Int. Cl. G06Q 10/10

(52) U.S. Cl. CPC G06Q 10/1053
USPC 705/321

(57) ABSTRACT

A new method for professionals to post their experience, expertise, and interests—while keeping this content understandable to a wide range of colleagues, up to date with current industry standards and definitions, and mediated of errors and misrepresentation.

The disclosed solution consists of a web-based database that stores experience, descriptions, publications, awards, interests, multi-media projects, credible references, and other forms of supporting information that portray the subject as a professional and expert in his or her domain—in short: a resume, curriculum vitae, or portfolio. The information in the database is displayed via a web-browser, client-side application, or human readable format, and is editable to the extent that the owner, subject, or administrator of the information allows. The changes made by visitors to the information can be submitted for review to the owner or included immediately for future discovery—depending on permission settings of the content.

### CROSS REFERENCE TO DISCLOSURE DOCUMENT

This invention “CrowdSourced Wiki Resume” was originally disclosed in provisional patent 61/619,928, filed by YouFolio LLC in 2012 naming Christopher R. Wirz as the inventor.

### BACKGROUND OF THE INVENTION

A resume is defined as a collection and brief account of one's experience and talent. A wild is a website whose users can add, modify, or delete its content via a web browser using a simplified markup language or a rich-text editor. CrowdSourcing is a distributed problem-solving and production process that involves out-sourcing tasks to a network of people, also known as the crowd. Therefore, a CrowdSourced Wiki Resume allows visitors to make changes to one's resume content in-line via a web browser so that this content can best leverage the subject for meaningful discovery and placement.

By allowing users to post their experiences, talents, and works on-line, a discoverable resume is created. This page is made editable using in-browser technology and server-side database storage. Because anyone can make a suggestion, the drive to refinement is sourced through the crowd. This unique approach that combines these well-known technologies is the major claim of this invention.

Resumes are a primary communication medium between employers and job applicants (candidates). Employers annually spend billions of dollars to solicit resumes using printed advertisements, job fairs, networking events, recruitment seminars, and other methods. In response, job applicants spend billions more to compose, format, typeset, print, and distribute this information.

The present resume delivery practices are exhausting (both in time and money) for professionals and employers. Employers browse many resumes before selecting a candidate to even interview, while professionals send out many resumes before being contacted for follow-up conversation. Ultimately, the success rate of the current resume practice is discouragingly low and most candidates would rather just accept a position than continue searching for one which may better match their talents.

With ever-changing roles, responsibilities, training, education, and experiences, it is tough for a professional to make sure that every potential employer or business partner is fully aware of his or her capabilities. Though on-line services such as Monster or JobFox serve as resume repositories, the responsibility of keeping this information up-to-date is levied on the professional. Further, the motivation to attend to this information is diminished since the content is not discoverable outside of the repository gateway and the professional is often unaware of mistakes or areas requiring clarification.

### FIELD OF THE INVENTION

The invention pertains to the field to electronic resume storage and retrieval systems and methods, employment services (in particular, to the field of providing employment services to users disposed at locations remote from each other), and document review/editing services.

### DESCRIPTION OF PRIOR ART

In the advent of digital storage, the challenges of searching and storing resumes has become relatively efficient for employers. Even paper resumes can be imaged using a scanner and processed into text using optical character recognition, as described in U.S. Pat. No. 7,991,776[1]. Employers can search text and keywords, and see ranked results, without having to manually search through hundreds of candidates. Once the information is obtained, the challenge is then selecting the better applicant. With many ways of formatting, or simply describing the same experience, it is often a challenge of interpretation to select a candidate—risking both employer and employee satisfaction.

Employers have attempted many variations of the resume in order to address this problem:
Direct Text Entry—Through most employment gateways—including BrassRing and Taleo (now Oracle), candidates must copy and paste the non-marked up content of their resumes into multiple form fields that categorize each piece of information. The end result is yet another iteration of the candidate's resume, which is often different for each employer, and many lines of unformatted plain text for employers to read before selecting a candidate. Though this makes resumes comparable with respect to formatting and length, the professional does not have the power of formatting to emphasize and draw attention to important complements of his or her resume.
Optical Character Recognition (OCR) Systems[1]—Searching through hundreds, or even just tens, of paper resumes can be tedious—even though the employer can get a better sense of what the candidate finds important in his or her education and experiences. OCR systems allow for the formatting of the resume to be maintained, but for the text to be searchable and indexable within a database, content management system, or data storage repository. The drawback of this system is that the candidate does not have the ability to edit the information rapidly since each submission is paper-based. Further, this one-time-approach would imply that the information indexed is not up to date and may be subject to errors and misrepresentations.

Video Resumes[2]—With the advent of streaming media, some employers have moved to requiring a video submittal from potential employees. This provides an employer with the ability to enjoy a brief one-way interview—which offers a little more personality than a textual resume. The drawback of this technology is that videos are not as easily indexed and searched. Further, the candidate must make video resumes for each opportunity he or she intends to pursue. Determining what to say and how to say it is an incredibly challenging task.

This invention allows a professional to edit his or her resume with full styling, but also to submit said information into a database that can be easily searched by employers. The contents of the database may be discovered by other visitors (“The Crowd”), whom may provide in-line suggestions and feedback accordingly. This allows the content of the professional's experience to appeal to a wide range of audience, emphasize recentness, and will avoid overstatements or understatements.
U.S. Pat. No. 7,991,776—Hartman (2011)

U.S. Pat. No. 7,991,776[1], filed Feb. 22, 2010, awarded Aug. 2, 2011 discusses a image-based “resume storage and retrieval system.” This invention “provides a method of and apparatus for storage and retrieval of resume images in a manner which preserves the appearance, organization, and information content of the original document.” Though this system “provides a user interface for creating the aforementioned resume outlines which is based on a familiar paper-based method already in common use, thus reducing the training required to effectively use the system,” it does not address the concerns of wide-spread comprehension and error-proofing. Though U.S. Pat. No. 7,991,776 uses a server to transmit “at least one of the resume graphics file in the first file format, or the converted file in the different file format,” it does not allow the user to convert between the two seamlessly.
U.S. application Ser. No. 11/202,772—Zanghi (2007)

U.S. patent application Ser. No. 11/202,772[2], filed Aug. 12, 2005, published Feb. 15, 2007 discusses “a video resume employment system.” This patent addresses a “video employment resume including employment information with respect to the job seeker for making an employment related determination by the employer.” Though this patent depicts a personalized multi-media representation of skills and experiences, the patent does not imply any type of indexing or keyword search beyond “providing said employer with a list of job seekers of said plurality of job seekers.”
U.S. Pat. No. 7,974,986—Toomey (2011)

U.S. Pat. No. 7,974,986[3], filed Jun. 30, 2006, awarded Jul. 5, 2011 discusses “A computer operated method for distributing a resume of a job seeker to career websites” which consists of “storing resume data from a job seeker within a storage area of a server computer” and logging “onto the next career website without user interaction using the user name and password.” Though the server mentioned in this patent is capable of “a plurality of instructions running on the server computer that capture resume data from a client computer and extract resume fields from the resume data,” the premise behind this invention is not to extract the fields, but to keep this information separated as possible so that the professional can control privacy settings on each resume element. In general, U.S. Pat. No. 7,974,986 involves a server that is capable of extracting and distributing resume data, but that data is disseminated and not iterated on by the professional.
U.S. Pat. No. 7,711,573—Obeid (2010)

U.S. Pat. No. 7,711,573[4], filed Apr. 18, 2003, awarded Apr. 4, 2010 discusses “A computer system and method for managing access to a resume database.” This patent utilizes “a contextual use for each skill or experience-related phrase, the contextual use having an experience range.” In its claims, U.S. Pat. No. 7,711,573 “determine[s] an experience range for each said at least one skill or experience-related phrase by examining a use of each said at least one skill or experience-related phrase in the resume; and compute[s] a term of experience for each said at least one skill or experience-related phrase based on the experience range.” In other words, a recruiter can specifically look for a candidate with a minimum number of years practicing a certain skill-set—which is determined by parsing a submitted resume. Further, U.S. Pat. No. 7,711,573 claims the system ranks phrases higher that are used in context, indicating a stronger experience utilizing that skill. This patent differs from the disclosed invention in that the disclosed invention focuses on the editing, discovery, and indexing of the resume, while this patent focuses on ranking and distributing the resume to recruiters or hiring managers. The main drawback of this patent with respect to the disclosed invention is that there is not feedback to improve results for employers or the quality (widespread comprehension and error-proofing) of a professional's resume.
U.S. Pat. No. 7,822,960—Dane (2011)

U.S. Pat. No. 7,822,960[5], filed Jul. 6, 2007, awarded Jan. 25, 2011 discusses “a resume database system allows for resume records on the resume database system to be viewed by others via a Uniform Resource Locator, URL.” Though this patent mentions the process of “being able to add information to the resume database without needing training on the operation of the database,” it does not reflect a feedback loop that focuses on continual refinement of the resume. This patent does state “as resume information is placed in the resume database, it can be compared to the stored searches. If there is a match between the candidate's credentials and the search criteria, a URL will be transmitted to the Hiring Manager. Thus, as soon as a candidate that matches a job opening's needs is entered in the database, the appropriate Hiring Manager will be notified.” This does not allow for a feedback loop because the hiring manager would be notified when a professional updates his or her information—therefore providing redundant notification. A benefit of U.S. Pat. No. 7,822,960 is that employers do not have to sift through email attachments or physical resumes. The resume content is stored in a database and is organized based on the relevancy to the employer's needs.

To summarize, a wide array of technologies, patents, and publications have developed solutions for submitting, transmitting, disseminating, and receiving resumes on-line. Though the disclosed invention also uses modem database processing (insert, update, query, etc.) methods and technology, the disclosed invention utilizes visitor in-line editing and suggestions (CrowdSourcing) to drive an iterative feedback loop which allows professionals to maintain a current, understandable, and low-error copy of his or her resume in an indexed, stylistically formatted, searchable database.

### SUMMARY OF THE INVENTION

An object of this invention is to reduce the time professionals spend editing their resumes by crowd-sourcing this effort to those who can discover these resumes.

It is a further object of this invention to reduce the time it takes employers to review a candidate's resume. Through the effort of crowd-sourcing, heightened language will be normalized, errors will be mitigated, and topics will be discussed in a manner that is easily understood by a mass audience.

It is a further object to preserve the stylistic features of a professional's resume through enriched-text editing of html markup. Modern web-browsers and client-side applications can take advantage of editable divisions of web-content and the markup language can be stored as text in most modern databases—or as ascii files on the server.

In view of the foregoing, the main object of this invention is to provide a technique for professionals to stay competitive in the job market through optimally depicting their skills and experiences utilizing the contributions of many peers. Further, the resultant depiction of expertise is discoverable through browsing or querying the database (or served files in a directory or content management system) in which this information is contained.

### BRIEF DESCRIPTION OF THE DRAWINGS

The invention will now be described in more detail, by way of example only, with reference to the accompanying drawings, in which:

FIG. 1 describes the process a professional takes in generating an initial resume.

FIG. 2 depicts the feedback loop which allows a professional to iterate on the text found within his or her resume.

FIG. 3 is an example of a rich text field that a visitor will have the ability to edit.

FIG. 4 is an example of a markup (html/code) editor of the same content of FIG. 3. The visitor may also have the ability to edit this content, though it is slightly more advanced than rich text editing.

### DETAILED DESCRIPTION OF THE DRAWINGS

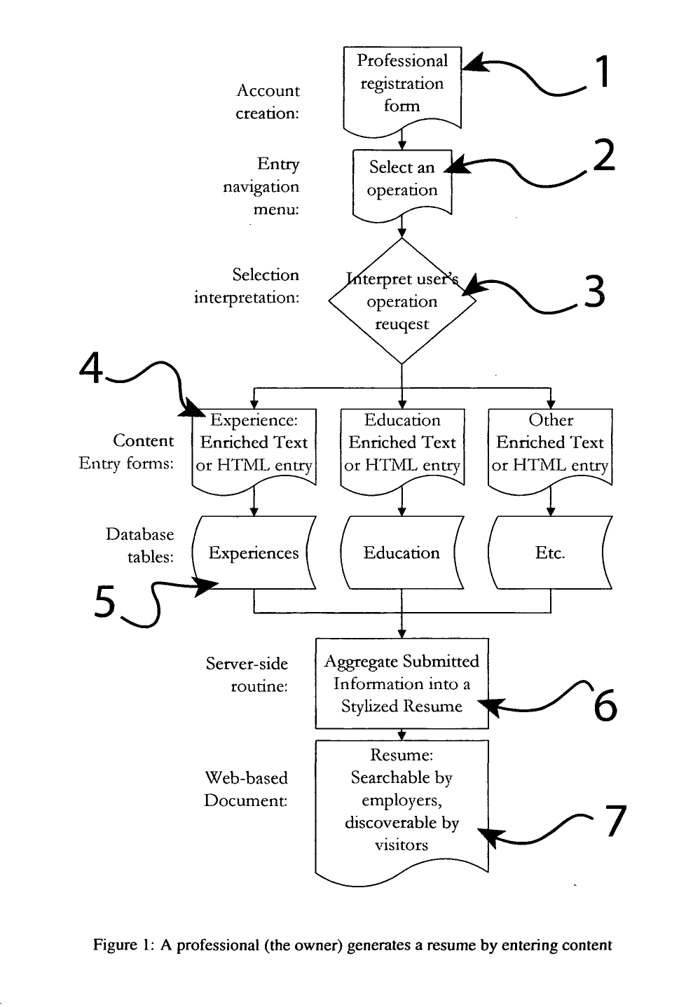

FIG. 1 depicts the process flow for creating an online resume that can practically be Crowd-Sourced. The first step a professional takes is to fill out the registration form (1). After the professional registers, he are she selects an operation to be performed (2). This selection indicates what information the professional will contribute. The selection is interpreted (3) and the information entry form is loaded (4), which allows the professional to provide content, style formatting, or both. After the information is entered, it is inserted or updated into a database table (5). For visitors, guests, other users, or administrators, the server aggregates a database query to build (6) a stylized resume. The resume is presented as a web-based document (7) that may be searched, discovered, or browsed.

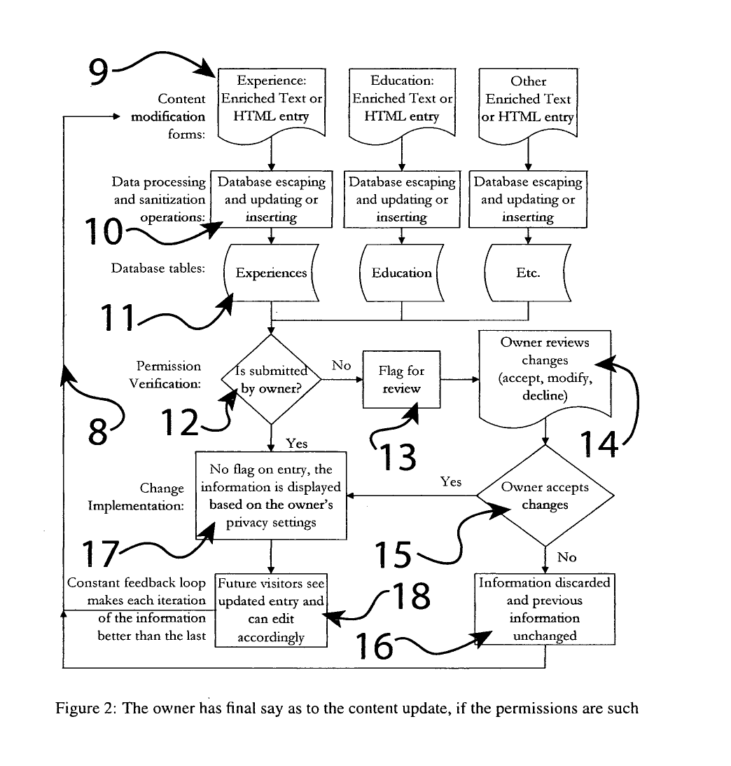

FIG. 2 depicts the process flow of iterating on a resume through a CrowdSourced feedback loop (8). The visitor can manipulate information on the screen (9) via Enriched Text or html/code. Once the information is submitted, it is escaped into a safe database format (10) and inserted into the corresponding database (11). A check (12) is then performed to determine if the owner has submitted the change or if a guest has submitted the change. If the owner is not the person submitting the change, the change is flagged (13) for review by the owner. The owner can then accept, modify, or reject the change (14). If the owner rejects the change (15), the information is deleted (16) and the previous information remains unchanged. If the owner accepts the change or the owner was the provider of the change (17), the change is implemented and future visitors to this site will see the information (18) and change it if they choose, based on privacy settings.

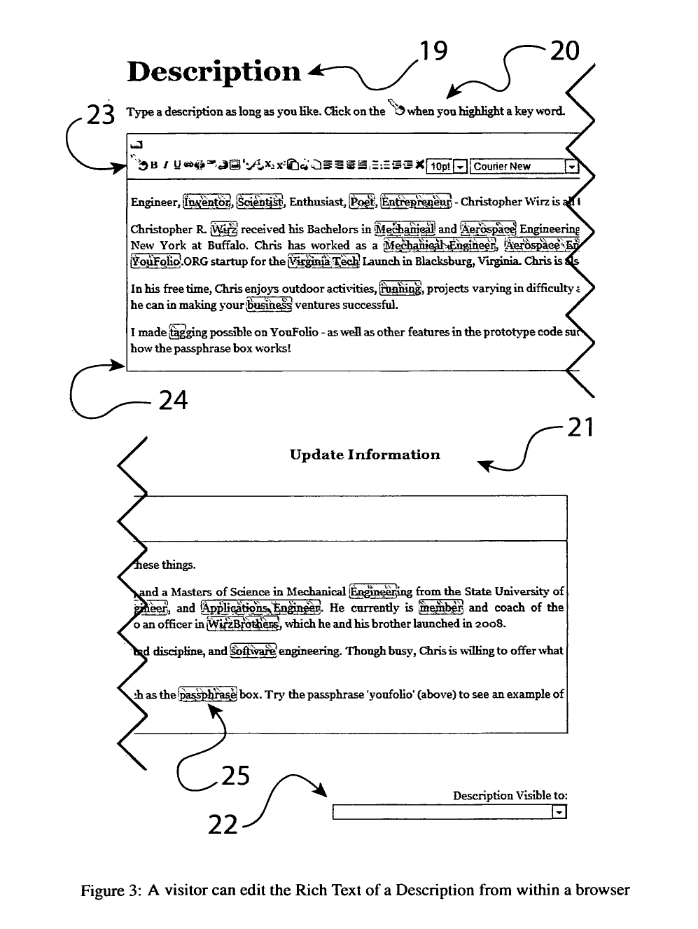

FIG. 3 depicts an interface, similar to the disclosed invention, which in this example allows a user to edit the description portion (19) of the resume. A brief dialog (20) highlights some of the functionality to the user. When complete, the user can elect to provide the update (21) to the information. If the owner is updating the information, additional privacy settings (22) may be set. A formatting bar (23) assists the user in adding style to the enriched text editing field (24). Further, the user has the ability to tag key words (25) to back link and add discoverability in searches.

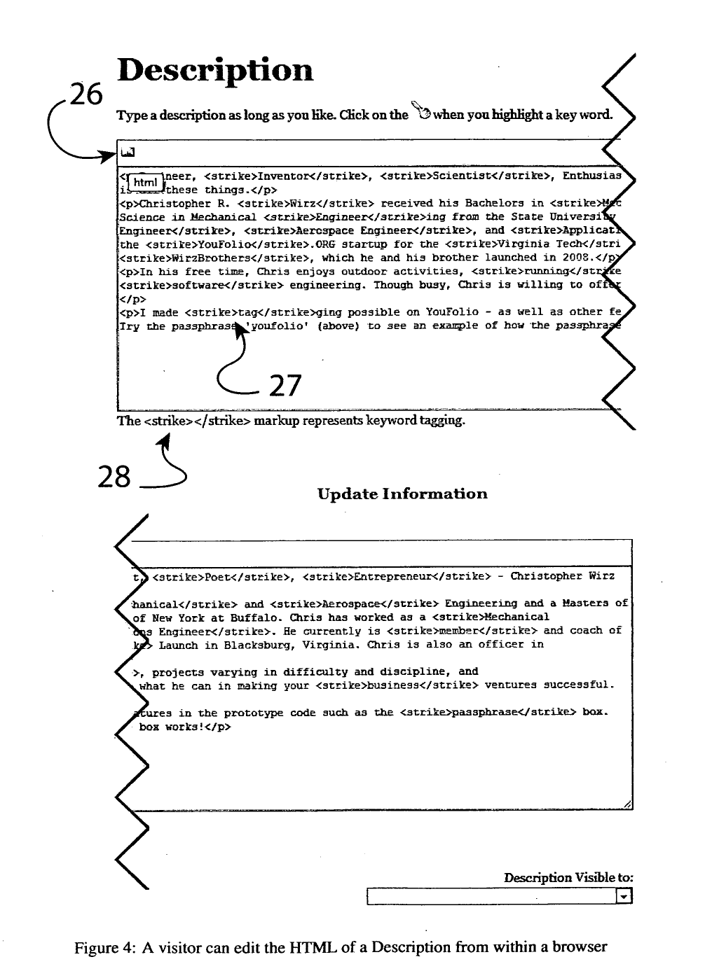

FIG. 4 depicts a text only/HTML (26)/code editing interface. The rich editing bar is gone from FIG. 3, but the HTML button (26) is still present to convert the field back to rich text editing. The markup (27) in the text retains the stylistic features but is in a human readable format. Below the editing field, advice is given (28) to prompt the user to make additions or to educate them as to effectively marking up the alphanumeric text.

While the invention shall now be described with reference to the preferred embodiments shown in the drawings, it should be understood that the intention is not to limit the invention only to the particular embodiments shown but rather to cover obvious alterations, modifications and equivalent arrangements possible within the scope of the claims.

No constraints are placed on the method of editing descriptive content, whether it be enriched text, graphical symbols, or plain text in nature. Common terminology for What You See Is What You Get (WYSIWYG) covers a reasonable spectrum of software titles and tools that may use their own proprietary formatting system. Storing the resume style and content in third-party formats is not excluded from the claims of this patent.

### ENHANCEMENTS

An enhancement possible with this patent is the ability to edit graphical content as well as text. With this enhancement, many client-side or in-browser applications, embedded objects, and plug-ins exist for editing images. Images are useful in providing personality to a resume and may be included in-line, floating, in a separate window, or as attachments. The current disclosed invention allows for uploading of new pictures—headshots or otherwise—but does not detail revision from within the document body of the resume. Image editing—and later audio-video editing—in conjunction with text editing—is a logical enhancement to the disclosed invention.

An enhancement possible with this patent is implementing of an update feed. As professionals accept or make modifications to their resumes, other users of the database can be alerted to that change. This allows for competition between users, feedback amongst users, and optimization of the resumes for the database users as a whole.

### BENEFITS OF THE INVENTION

This invention benefits consumers by expediting the resume preparation process, as well as the applicant comparison process. Changing the paradigm of the resume through CrowdSourcing technology assists in reducing heightened language or overstatements. After repeated iterations of the suggestion and modification feedback loop, resumes are conventionalized for a widespread audience. This allows employers to better ascertain a direct comparison between two candidates. In order to achieve a candidate short-list, the invention is built on common database knowledge and processes which allow traditional operations such as insert, update, select, drop, and general query methods. This invention can be implemented on currently existing systems, and saves professionals' time in leveraging themselves through the resume improvement process.

This invention provides an inclusive venue for persons to accept and critique the way they describe and others describe personal abilities and experiences to the world. With proper use of privacy settings, a visitor can edit a resume with no name on it—in other words the owner is unknown—allowing for unbiased peer review. Additionally, the owner can allow for anonymous guest editing, meaning that the contributor will not be judged based on the caliber of his or her proposed change—and the change will not be judged based on the caliber of the contributor.

### Other Embodiments

From the foregoing description, it will thus be evident that the present invention provides a solution to expedite the iterative process of refining a resume, through the use of crowd-source and wild editing technology. Similarly, the present invention results in a product that employers can use to better compare potential employees and aggregate through common database operations.

Variations or modifications to the design and construction of this invention, within the scope of the appended claims, may occur to those skilled in the technology, upon reviewing the disclosure herein (especially to those using flow-chart or modeling language design systems). Such variations or modifications, if within the spirit of this invention, are intended to be encompassed within the scope of any claims to patent protection issuing upon this invention.

While particular embodiments have been disclosed, it is understood that the invention is not limited. Modifications may be made by those skilled in programming and information systems. The appended claims cover many such modifications that incorporate those features which constitute the essential features of the present invention.

### REFERENCES

[1] Richard L. Hartman et. al. “Resume storage and retrieval system”. U.S. Pat. No. 7,991,776 (Dublin, Calif.). August 2011. URL: http://www.patentlens.net/patentlens/patent/US_{—}7991776/.
[2] Benjamin L. Zanghi J R. et. al. “Video Resume Internet System”. Application US 2007/0038636 A1 (Philadelphia, Pa.). February 2007. URL: http://www.patentlens.net/patentlens/patent/US_{—}2007_{—}0038636_A1.
[3] Paul Toomey et. al. “System, method and computer program products for resume blasting”. U.S. Pat. No. 7,974,986 (Palm Harbor, Fla.). July 2011. URL: http://www.patentlens.net/patentlens/patent/US_{—}7974986/.
[4] Diya B. Obeid. “Resume management and recruitment workflow system and method”. U.S. Pat. No. 7,711,573 (New York, N.Y.). April 2010. URL: http://www.patentlens.net/patentlens/patent/US_{—}7711573/.

[5] Mark Dane et. al. “Method and apparatus for sending and tracking resume data sent via URL”. U.S. Pat. No. 7,877,354 (Wayne, Pa.). January 2011. URL: http://www.patentlens.net/patentlens/patent/US_{—}7877354/.

The embodiments of the invention in which the inventors claim an exclusive property or privilege are defined as follows:

1. A new method for iterating on resume improvement and discovery through use of “Crowd-Sourced” editing, combining: a defined method of content revision and database transactions; a client-side application interface for editing in enriched-text, text-only, or proprietary style-enhanced data types; a database or content management system allows for replacement, version control, revising, and pending revisions; and a method of permission and privacy settings allowing editing for a range of visitor groups at determined periods of time.

2. Permission settings, of the claim 1, wherein the owner may review suggestions before changes affect the displayed information, the “CrowdSource” changes may be immediately implemented and any changes are at the approval of the system administrator or content owner, any changes may generate a new revision or version of the resume data, pending changes are viewable or not viewable by other users as determined by owner-defined permission settings, or changes and suggestions are disallowed by either the owner or administrator for any amount of time.

3. Privacy settings, of the claim 1, wherein set groups, individuals, interne protocol addresses, emails, user accounts, passphrases, latency, client application, or intermittent restriction have specified access in terms of contributing, editing, or uploading of content, style, data format, language, or sectioning.

4. The database or content management system, of the claim 1, wherein the location may be in memory, on cloud, on network, on hard disk, on processor, on removable media, on attached storage, file storage, or at a remote location.

5. The client-side application, of the claim 1, wherein said viewer, owner, or administrator may browse, query, update, insert, or append information may be conducted through a web-browser, text-editor, client-side executable, or interpreted language script. The language of the client may be in java, flash, silverlight, html, html5, svg, another web-scripting language, mobile application, compiled executable, interpreted language, or other sensible graphical user interface (GUI).

6. The “crowd”, of the claim 1, may be derived from calls to action, message boxes, requirements to continue browsing, email deliveries, mouse-over edit enabling, the ability to submit a file, monetary incentive, access to a job opening database, karma, search engine promotion, reciprocity, limited time offer, or community participation.

7. The act of editing, of the claim 1, wherein said modification may include sectioning, error correction, change of spoken language, change or read language, upload or posting of multi-media content, style changes, reference linking, keyword splitting or joining, the addition of advertisements, adding a signature field, adding client-interpreted code, adding server-executable code, image inclusion, passage omission, quoting or citing, heightened vocabulary, syntax or conjugation correction, or the addition or removal of text or multi-media content.

8. An interface for in-line, rich-text or plain-text, editing of resume content that can be displayed in the following states: static un-editable stylized or plain text; dynamic editable stylized text (rich text) or plain text.

9. Plain text, of the claim 8, wherein the format may be in ascii, extended ascii, or any similar character encoding scheme.

10. Stylized text or rich text, of the claim 8, wherein the file format may be any proprietary or non-proprietary enriched text, marked up text, mimetype, or other document file format and typesetting.

11. In-line editing, of the claim 8, may be presented in another window, another part of the document, a client-side upload, server-side include, or file parsing interface: both human readable or non-human readable.
